(19) United States
(12) Patent Application Publication
(10) Pub. No.: US 2009/0152317 A1
(43) Pub. Date: Jun. 18, 2009

(54) NAIL GUN WITH INTERGATED CYLINDER

(75) Inventor: Joe LIN, La Mirada, CA (US)

Correspondence Address: BROWDY AND NEIMARK, P.L.L.C.;624 NINTH STREET, NW, SUITE 300, WASHINGTON, DC, 20001-5303, US

(73) Assignee: Sandy LIN, La Mirada, CA (US)

(21) Appl. No.: 11/957,947

(22) Filed: Dec. 17, 2007

(51) Int. Cl. B25C 1/00

(52) U.S. Cl. 227/120

(57) ABSTRACT

A nail gun includes a gun body, an upper lid, a grip, a magazine, and a valve. The gun body includes a cylinder having an upper section, on which an inlet is provided, and a lower section, in which a piston and a shaft are received. The valve, which is a disk-like member, has a leakproof device on an edge thereof, a post at a center thereof having a bore along a diametric direction, and a leakproof portion on a bottom thereof. The valve is received in the upper section of the cylinder with the leakproof device against a sidewall of the cylinder to generate an airtight condition.

### BACKGROUND OF THE INVENTION

1. Field of the Invention

The present invention relates generally to a nail gun, and more particularly to a nail gun having an integrated cylinder.

2. Description of the Related Art

For a conventional nail gun, it usually has a gun body, in which a cylinder and a piston are provided. The gun body further includes an upper lid on a top thereof and a valve within the upper lid. The valve is covered on a top of the cylinder to provide an airtight condition. Such structure has a drawback, which is, there must be an airtight condition between the valve and the upper lid that the valve may function normally. However, the upper lid usually is made by metal casting that an interior surface is not smooth enough. To obtain an airtight condition between the valve and the upper lid, the upper lid must be polished before it is mounted on the gun body. The extra polishing process increases the cost of product and lowers product's competition in the market.

### SUMMARY OF THE INVENTION

The primary objective of the present invention is to provide a nail gun, which has an integrated cylinder to lower the cost and to increase product's competition in the market.

According to the objective of the present invention, a nail gun includes a gun body, an upper lid, a grip, a magazine, and a valve. The gun body includes a cylinder having an upper section, on which an inlet is provided, and a lower section, in which a piston and a shaft are received. The valve, which is a disk-like member, has a leakproof device on an edge thereof, a post at a center thereof having a bore along a diametric direction, and a leakproof portion on a bottom thereof. The valve is received in the upper section of the cylinder with the leakproof device against a sidewall of the cylinder to generate an airtight condition.

### BRIEF DESCRIPTION OF THE DRAWINGS

FIG. 1 is an edge view of a first preferred embodiment of the present invention;

FIG. 2 is a sectional view along the 2-2 line of FIG. 1;

FIG. 3 is a sectional view along the 3-3 line of FIG. 1;

FIG. 4 is a sectional view of the first preferred embodiment of the present invention, showing the cylinder and the valve; and

FIG. 5 is a partially sectional view of a second preferred embodiment of the present invention, showing the cylinder, the upper lid and the valve.

### DETAILED DESCRIPTION OF THE INVENTION

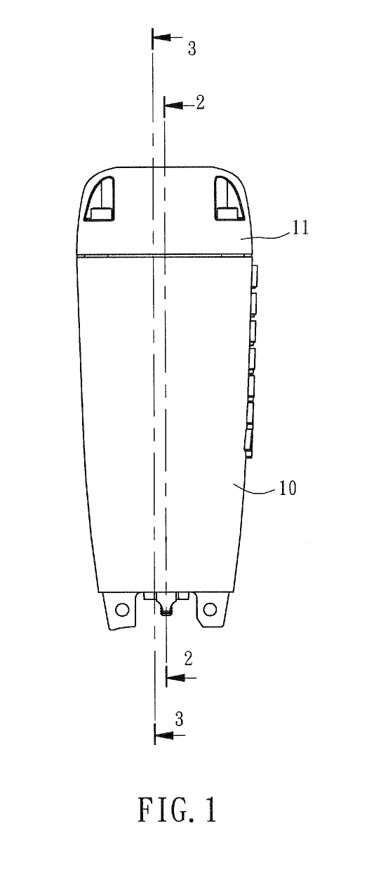

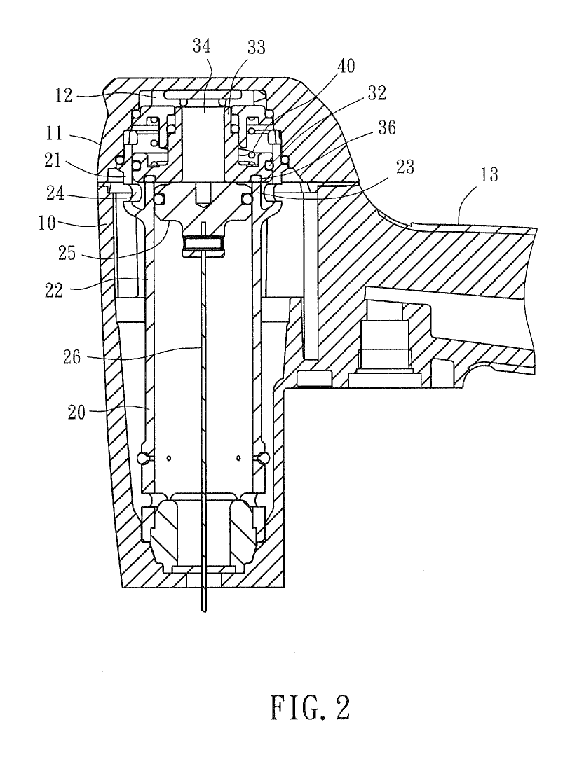

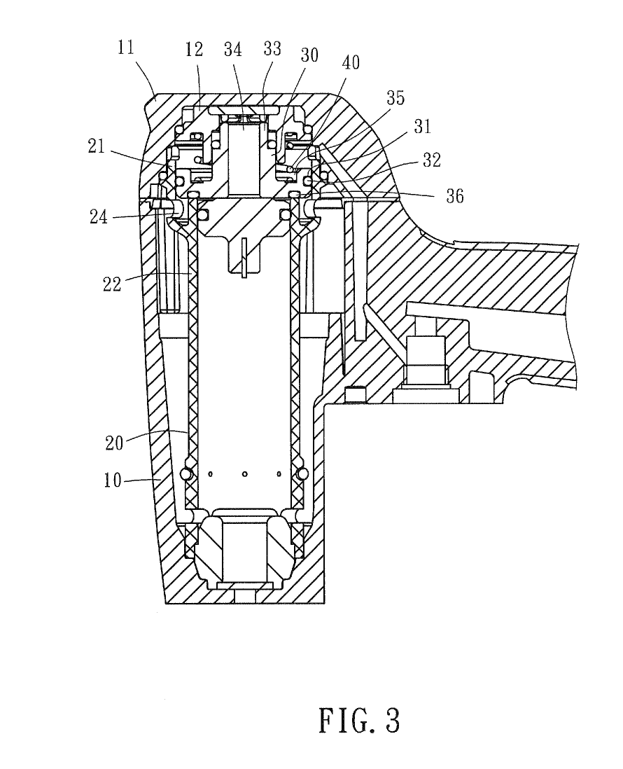

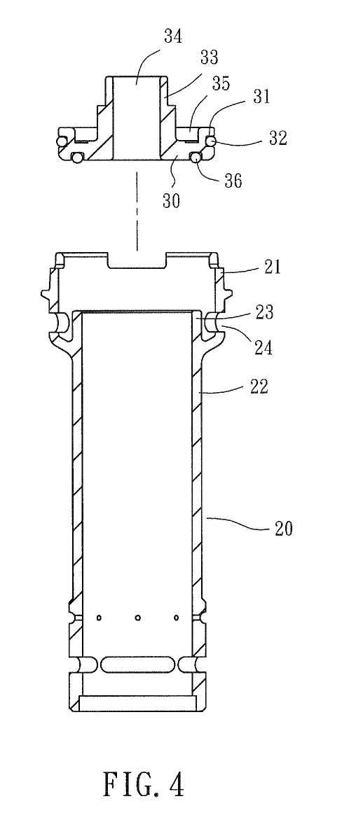

As shown in FIG. 1 to FIG. 4, a nail gun of the first preferred embodiment of the present invention includes a gun body 10, an upper lid 11, a body lid 12, a grip 13, and a magazine (not shown), wherein the upper lid 11, the body lid 12, the grip 13, and the magazine are as same as the conventional nail gun, so we do not describe their details here.

The gun body 10 includes a cylinder 20 therein. The cylinder 20 defines an upper section 21 and a lower section 22, wherein the upper section 21 has a diameter greater than that of the lower section 22, and there is an annular portion 23 between the upper section 21 and the lower section 22. The annular portion 23 extends into the upper section 21 to make the upper section 21 and the lower section 22 overlapped here and surround outside of the lower section 22. On the overlapped portion is provided with an inlet 24. A piston 25 and a shaft 26 are received in the lower section 22.

A valve 30, which is a disk-like member, has an annular slot 31 on an edge thereof, in which a leakproof device 32 is provided. The valve 30 further has a post 33 at a center thereof, which has a bore 34 along a diametric direction, a recess 35 on a top thereof surrounding the post 33, and a leakproof portion 36 on a bottom thereof. The valve is received in the upper section 21 of the cylinder with the leakproof device 32 on the edge thereof against a sidewall of the cylinder to produce an airtight condition.

An elastic device 40, which is fitted to the post 33 of the valve 30, has an end received in the recess 35 on the top of the valve 30 and an opposite end urging an interior side of the upper lid 11.

With the structure described above, the nail gun of the present invention operates as same as the conventional nail gun. Because the top and the bottom of the valve has the same size, so when user triggers the nail gun of the present invention, the pressure on the top of the valve will decrease to make the valve being moved upwards and compressing the elastic device to let high pressure gas flowing into the cylinder via the inlet to move the piston and shaft in the lower section downwards for firing a nail. When user releases the trigger, the pressure on the top of the valve increases to normal that the elastic device will return the valve to the initial position and let the gas in the cylinder flowing out via the bore on the post.

The advantage of the present invention is that the valve is provided in the cylinder directly and forms an airtight condition in the cylinder, so that there is no need an extra polishing process on the cylinder to achieve the airtight condition. Beside that, the assembling task of the present invention is simple also.

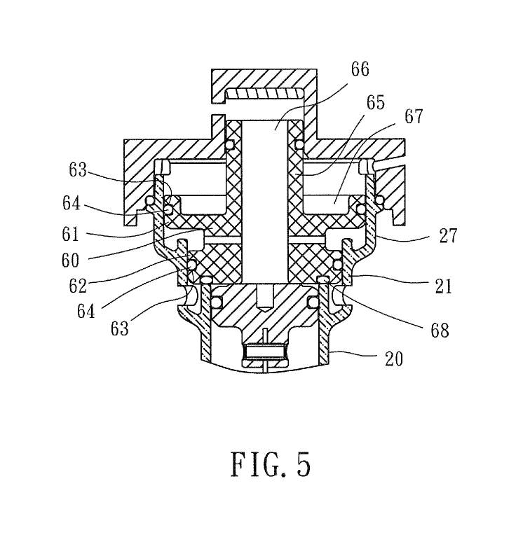

As shown in FIG. 5, a nail gun of the second preferred embodiment of the present invention, which is similar to the first preferred embodiment, includes a gun body, an upper lid, a grip, and a magazine. The different part of the second preferred embodiment is that the cylinder 20 further is provided with an out expanding section 27 above the upper section 21. A diameter of the out expanding section 27 is greater than that of the upper section 21.

A disk 60 is a disk-like member with an upper layer 61 and a lower layer 62. The upper and lower layers 61, 62 have different diameters; the upper layer 61 is greater than lower layer 62. The disk 60 has an annular slot 63, in which a leakproof device 64 is received, between the upper and lower layers 61, 62, a post 65 at a center thereof with a bore along a diametric direction, a recess 67 on a top thereof surrounding the post 65, and a leakproof portion 68 on a bottom of the lower layer 62. The valve 60 is received in the cylinder 20 with the leakproof device on the upper layer 61 against a sidewall of the out expanding section 27 to generate an airtight condition and with the leakproof device on the lower layer 61 against a sidewall of the upper section to generate an airtight condition.

With the structure of the second preferred embodiment of the present invention, when user triggers the nail gun, the pressure on the top of the valve will decrease to move the valve upwards, so that high pressure gas will flow into the cylinder via the inlet and move the piston and the shaft to fire a nail. When user releases the trigger, the pressure on the top of the valve increases to normal that the valve will return to its initial position and permit the gas in the cylinder flowing out via the bore on the post. The different part is that the size of the upper layer is greater than that of the lower layer that the pressure on the top of the valve is greater than that on the bottom when the pressure on the top of the valve return to normal, so that using the pressure difference between the top and the bottom of the valve will force the valve moving downwards automatically without the biasing force of the elastic device. The nail gun of the second preferred embodiment has all of the functions of the first preferred embodiment, besides, it has a more simple structure to increase the product's stability and competition.

The description above is a few preferred embodiments of the present invention and the equivalence of the present invention is still in the scope of the claim of the present invention.

What is claimed is:

1. A nail gun, comprising:
a gun body, an upper lid, a grip, and a magazine, wherein the gun body includes a cylinder having an upper section, on which an inlet is provided, and a lower section, in which a piston and a shaft are received;
a valve, which is a disk-like member, having a leakproof device on an edge thereof, a post at a center thereof with a bore along a diametric direction, and a leakproof portion on a bottom thereof, wherein the valve is received in the upper section of the cylinder with the leakproof device against a sidewall of the cylinder to generate an airtight condition.

2. The nail gun as defined in claim 1, wherein a diameter of the upper section of the cylinder is greater than that of the lower section, and an annular portion is formed between the upper section and the lower section and extends into the upper section to overlap the upper section and the lower section and to surround outside of the lower section, and the inlet is provided at the overlapped portion.

3. The nail gun as defined in claim 2, wherein the cylinder has an out expanding section, which a diameter thereof is greater than that of the upper section, above the upper section.

4. The nail gun as defined in claim 3, wherein a size of the top of the valve is greater than that of the bottom of the valve.

5. The nail gun as defined in claim 4, wherein the valve has an upper layer and a lower layer, which a size of the upper layer is greater than that of the lower size, with the leakproof device on the upper layer against a sidewall of the out expanding section to generate an airtight condition and with leakproof device on the lower layer against a sidewall of the upper section to generate an airtight condition.

6. The nail gun as defined in claim 1, further comprising an elastic device, which is fitted to the post of the valve, having an end urging the top of the valve and an opposite end urging an interior side of the upper lid.

7. The nail gun as defined in claim 1, wherein the valve has a recess on the top thereof and surrounding the post to receive the end of the elastic device therein.
